(19) United States
(12) Patent Application Publication
(10) Pub. No.: US 2011/0001432 A1
(43) Pub. Date: Jan. 6, 2011

(54) LIGHT EMITTING DEVICE WITH COMPENSATION CAPABILITY

(75) Inventors: Chin Kan Chung, Junghe (TW); Shu Kang Huang, Junghe (TW); Cheng Chung Wu, Junghe (TW)

Correspondence Address: BAKER & MCKENZIE LLP;PATENT DEPARTMENT, 2001 ROSS AVENUE, SUITE 2300, DALLAS, TX, 75201, US

(73) Assignee: UPEC ELECTRONICS CORP., Junghe (TW)

(21) Appl. No.: 12/830,705

(22) Filed: Jul. 6, 2010

(30) Foreign Application Priority Data
Jul. 6, 2009 (TW) 098122814

(51) Int. Cl. H05B 37/02

(52) U.S. Cl. 315/152; 315/297; 315/185 R

(57) ABSTRACT

A light emitting device with compensation capability is disclosed herein which includes a plurality of light emitting diodes, when a light emitting diode is out of order, the remaining of the light emitting diodes can still working properly; a status detecting unit; a power controlling unit; a processing unit to provide the control signals to the power controlling unit in order to dynamically provide the power to the light emitting diodes. By utilizing the LED device with light compensation capability, it can provide the stable power compensate.

### RELATED APPLICATION

The present application claims priority under 35 U.S.C. 119(a) to Taiwan application number 098122814 filed on Jul. 6, 2009, which is incorporated herein by reference in it's entirety as if set forth in full.

### FIELD OF THE INVENTION

The present invention relates to a light emitting diode device, especially relates to a light emitting diode device with a compensation capability.

### BACKGROUND

LED (Light Emitting Diode, abbreviated LED) family is born in 60s, and at first, red LED comes, and then green LED and blue light LED come in order. However, until 1998, LED product come to the market. LED has various advantages, such as energy saving, fast switching, etc. Currently, LED is enormously used for indication, which is the first application for LED, such as outdoor LED displays, LED traffic lights and LED flat ceiling lights, but with the trend to adopt LED as a backlight source of cell phones is growing, LED has developed a new application.

The implementation of LED application is quite general, from the cell phones, small devices, for example: remote controller, etc in early days to cars, lights, outdoor large displays, etc in the near future, due to high-brightness LED presented to the public. Beside, for the natures of great color rendering, fast initiating, free from mercury and long life-term, when LED is used as light source or backlight source, display is the potential product for LED.

Recently, LED is more and more popular to be used in various kinds of displays, from outdoor large displays to projectors and even to liquid crystal televisions and liquid crystal monitors of personal computers. The request for better reliability is even more with the growing of the size of such products. If any LED of a LED array is broken, conventional LED does not provide compensation capability for this issue, and hence not only the conformity of the illumination of the LED array will be effected, but the lifetime of the LED array will be shortened when the components of the LED array are overheated by excessive voltage drop on lines.

Therefore, a modified LED device is required to solve above problems by providing a compensation capability.

### SUMMARY OF THE INVENTION

An object of the present invention is to provide a LED device to solve one of the problems in prior art, such as floating voltage or unstable current when a LED is out of order, and shortened lifetime due to varied illumination and overheated components.

According to the present invention, a LED device is provided, comprising: a plurality of light emitting diodes, when at least one of the plurality of light emitting diodes is out of order, the remaining of the plurality of light emitting diodes can still working properly; a status detecting unit, coupling to the plurality of light emitting diodes; a power controlling unit, providing a power outputted to the plurality of light emitting diodes; and a processing unit, instructing the power controlling unit to adjust the power outputted to the plurality of light emitting diodes according to status signals provided by the status detecting unit.

According to an embodiment of the present invention, each of the plurality of LED is with a corresponding LED protecting unit.

According to an embodiment of the present invention, wherein the status detecting unit comprises voltage detector or current detector. Additionally, according to another embodiment of the present invention, wherein the status detecting unit further comprises an ambient light sensor.

According to some embodiments of the present invention, wherein when at lease one light emitting diode of the plurality of light emitting diodes is out of order, the processing unit instruct the power controlling unit to lower a total input voltage of the plurality of light emitting diodes according to the status signals provided by the status detecting unit, and increase current of respective light emitting diodes to compensate brightness.

According to another object of the present invention, a LED device is provided, comprising: a plurality of light emitting diodes, when at least one of the plurality of light emitting diodes is out of order, the remaining of the plurality of light emitting diodes can still working properly; a status detecting unit, coupling to each of the plurality of light emitting diodes; a power controlling unit, providing a power outputted to the plurality of light emitting diodes; and a processing unit, instructing the power controlling unit to adjust the power outputted to the plurality of light emitting diodes according to status signals provided by the status detecting unit; wherein the plurality of light emitting diodes are separated into a first group and a second group, and the first group and the second group comprise respective power controlling signals and status detecting signals.

According to an embodiment of the present invention, wherein the first group comprises the plurality of light emitting diodes in odd number positions of each row, and the second group comprises the plurality of light emitting diodes in even number positions of each row.

According to further object of the present invention, a LED system is provided, comprising: a light emitting diode array, when at least one light emitting diode of the light emitting diode array is out of order, the remaining light emitting diode in the light emitting diode array can still working properly; an image capturing system, detecting brightness of the light emitting diode array; a power controlling unit, providing a power outputted to the plurality of light emitting diode array; and a processing unit, instructing the power controlling unit to adjust the power outputted to the light emitting diode array according to the signals provided by the image capturing system.

The features illustrated here and combinations among them are all within the scope of the present invention for the skill in the art according to the specification and embodiments, as long as the features is not naturally contradictory. Additionally, other than those excluded patently in the specification, all embodiments of the present invention fall into the scope of the present invention. The structure and method of the present invention have been disclosed by preferred embodiments for example and reference as followed, and at the mean time, it is noted that such embodiments and examples are only exemplary but not for limiting the present invention. The scope of the present invention is only defined in claims. These and other objects, features and embodiments will be illustrated in the following paragraphs.

### BRIEF DESCRIPTION OF THE DRAWINGS

FIG. 1 shows a block diagram of a LED device with compensation capability of an embodiment of the present invention.

FIG. 2 shows a perspective view with a row of LEDs for illustrating the operation of an embodiment of the present invention.

FIGS. 3 and 4 show layout schemes of the LED devices with compensation capability of different embodiments according to the present invention.

FIG. 5 shows a layout scheme of the LED devices with compensation capability of another embodiment of the present invention.

FIG. 6 shows a prescriptive view of a system arrangement of the LED devices with compensation capability of another embodiment of the present invention.

### DETAILED DESCRIPTION OF THE INVENTION

The invention is described in detail below with reference to drawings for purposes of exemplification and illustration for some embodiments of the present invention only. Modifications to particular embodiments within the spirit and scope of the present invention, set forth in the appended claims, will be readily apparent to those of skill in the art. The drawings are not drawn precisely in proportion, but similar reference numbers are usually for similar elements.

Paragraphs followed will illustrate LED devices with compensation capability of some embodiments of the present invention with reference to related drawings.

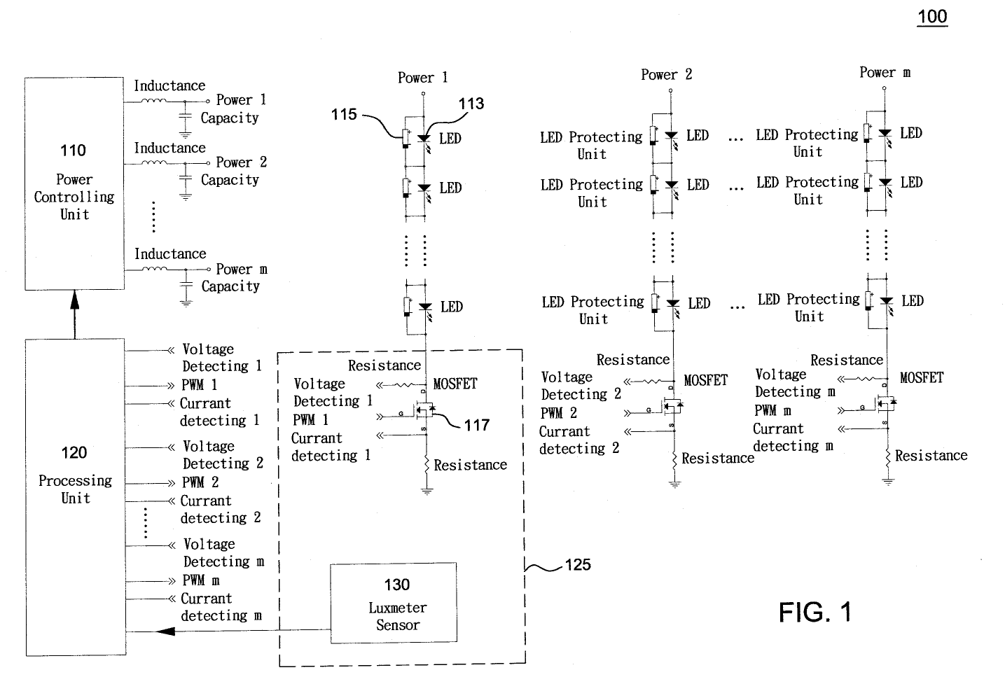

Please refer to FIG. 1 which shows a block diagram of a LED device with compensation capability of an embodiment of the present invention. As shown, the device comprises a LED array 100 comprising a plurality of LEDs in serial connection as an unit. In the present example, the LEDs are arranged into rows marked 1, 2 . . . m. Each row has respective power source (power 1, power 2 . . . power m) and connects to a power controlling unit 110. Additionally, each LED, for example the one marked 113, is parallelly connected to a LED protecting unit, for example the one marked 115, and this can provide a redundant path for bypassing a malfunctioned LED when any LED is out of order. Then, other LEDs in the same row will not be effected by the malfunctioned LED. In the end of the plurality of LEDs in serial connection of the device a detecting unit 125 is further comprised for detecting the status of the plurality of LEDs in serial connection, such as current or voltage, and transmitting the detected status to a processing unit 120 for processing. Besides, the detecting unit 125 can also comprise an ambient light sensor 130 for sensing the brightness of the LED array 100 or a LED in any position. Certainly, the power controlling unit 110 can also be integrated with the processing unit 120 to a single power controlling and processing unit.

A feature of the present invention is to solve one of the problems in the prior art, such as floating voltage or unstable current when a LED is out of order, and shortened lifetime due to varied illumination and overheated components.

If one (or more than one) LED is out of order, the present invention protect normal operations of other LEDs with a LED protecting unit, calculates and determines varied amount of the voltage or current of the LEDs with feedback signals, such as voltage detecting 1 or current detecting 1 in FIG. 1, of a voltage detecting circuit or a current detecting circuit of a detecting unit in a processing unit to correspondingly adjust the output of a power controlling unit. Therefore, the illumination loss due to the malfunctioned LED is thus compensated to prevent heat generated by voltage drop of the malfunctioned LED from transferring to other parts.

In one embodiment of the present invention, the voltage detecting circuit of the detecting unit 125 detects the sum of the voltage conducting in each row of the LEDs and transmits the sum to the processing unit 120. The current detecting circuit detects the current conducting in each row of the LEDs and transmits the result to the processing unit 120. However, in the other embodiments of the present invention, the detecting unit 125 may comprise a PWM controlling signal for receiving signals from the processing unit 120. With the adjustment of the PWM controlling signal for the MOSFET 117, the brightness of each row of the LEDs can be controlled.

In one embodiment of the present invention, the processing unit 120 receives feedback signals from the voltage detecting circuit or the current detecting circuit, such as voltage detecting 1 or current detecting 1. When a LED is out of order (for example, open/short failure), through the detecting mechanism, the voltage and PWM output signals can be calculated and adjusted to achieve steady power.

In one embodiment of the present invention, an ambient light sensor 130 is further comprised. Therefore, when the brightness is not sufficient, the brightness feedback signals can be transmitted to the processing unit 120 for the processing unit to increase voltage or current to compensate the brightness.

Here is the details to illustrate how the LED device with compensation capability of the present invention work via an embodiment.

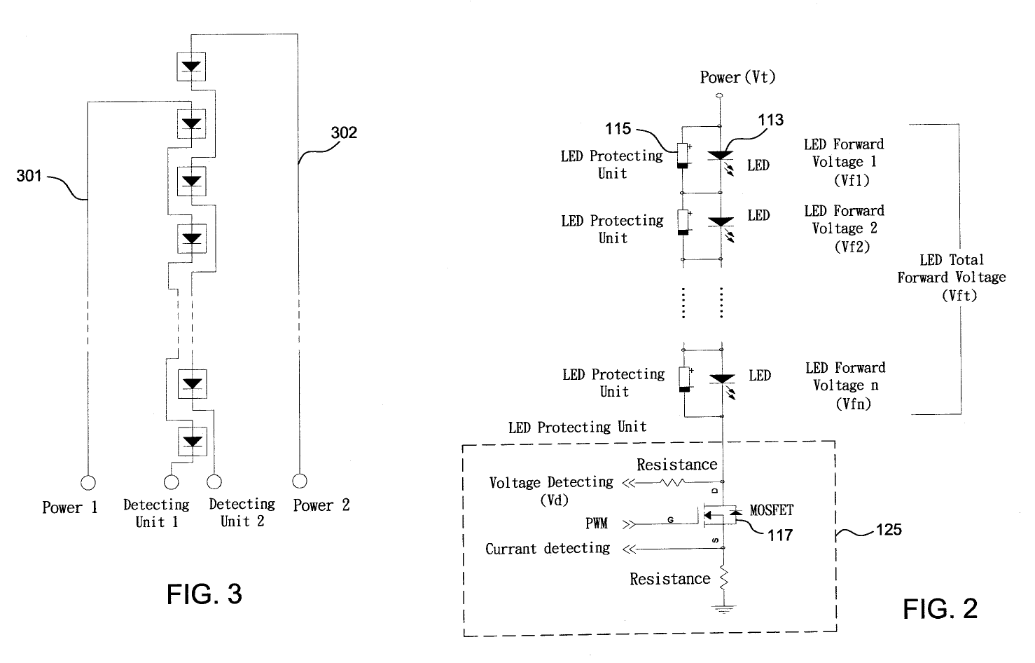

Please refer to FIG. 2. In the present embodiment, it is exemplary for illustration by only one row of LEDs. The row of LEDs comprises n LEDs (1, 2 . . . n). Please noted that it is easy to apply the spirit of the present invention to the embodiments with a LED array comprising several rows of LEDs.

As shown, each row of the LEDs operates follow the formulas listed bellow:

Vft=Vf1+Vf2+ . . . +Vfn

Vt=Vft+Vd

Vd=Vt−Vft

wherein, P is a total power consumption of the LED row;

ΔVf is a changed amount of the forward voltage due to the malfunctioned LED;

ΔVd is a changed amount of the detected voltage;

ΔP is a power loss amount;

ΔI is a current compensate amount.

When a LED is out of order (such as open or short failure), the processing unit will adjust according to one of the steps listed below or any combination among the steps:

1. adjusting voltage:
When the voltage is out of order, Vd=Vt−(Vft−ΔVf)

So, ΔVd=ΔVf

At this time, the processing unit adjust a total output voltage Vt of the power controlling unit to lower ΔVd, and prevent heat generated due to the voltage drop of the malfunctioned LED from transferring to other parts.

2. compensating power

P=Vft*I (current)

After the voltage is adjusted, ΔP=ΔVd (which equals to ΔVf)*I (current)

For compensating the brightness loss of ΔP, it is needed to add a compensating current ΔI

Then, P=Vft*I=(Vft−ΔVd)*(I+ΔI)

ΔI=(ΔVd/(Vft−ΔVd))*I

to stable power output to compensate illumination loss due to the malfunctioned LED.

3. ambient light sensor (not shown in FIG. 2)

While the brightness is not sufficient, the brightness feedback signals can be further transmitted to the processing unit to make the processing unit increase the voltage or current to compensate the brightness.

Though in the abovementioned embodiments only one row of LEDs is used for illustration, it is noted that the spirit of the present invention can be easily applied to those with a LED array comprising multiple rows of LEDs, and the present invention also can be implemented with different layouts to get an even better compensation result.

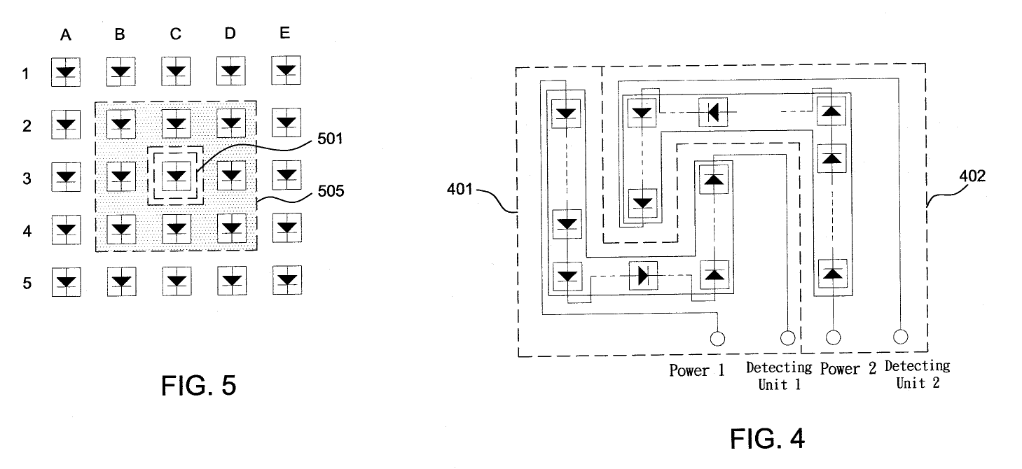

Please refer to FIGS. 3 and 4, which show layout schemes of the LED devices with compensation capability of different embodiments according to the present invention. In FIG. 3, a layout scheme of LED devices with compensation capability arranged in single row of LEDs of an embodiment of the present invention is shown. The single row of LEDs can be divided into two groups, one is an odd number group 302, the other is an even number group 301. Then, the two groups are connected to different power controlling lines (for example: the lines marked power 1 and power 2 shown in FIG. 3) and detecting units (for example: the detecting unit 1 and the detecting unit 2 shown in FIG. 3). In such arrangement for combining LEDs and constructing PCB layout, both problems of layout limitation in single-layered PCB and difficulty to consider brightness compensation by areas are solved. Hence, the problems of difficulty to compensate white balance and power waste due to too many LEDs serially connected in the same row are also solved. Similarly, in FIG. 4, a layout scheme for LED devices with compensation capability in a LED array of an embodiment of the present invention is shown. Similarly, the LED array can be divided into two groups, one is a first group 401 and the other is a second group 402. Then, the two groups are connected to different power controlling lines and detecting units. Surely, if LED array is divided into more groups to be controlled in greater details, such modification is within the scope of the present invention.

While any one (or more) LED is out of order, the processing unit can initiate the aforementioned compensation capability to recover the loss in brightness to maintain required illumination and conformity.

Please refer to FIG. 5, which shows a layout scheme of the LED devices with compensation capability of another embodiment of the present invention. In the present example shown in FIG. 5, in the 5×5 LED array (with rows A˜E and columns 1˜5), each LED owns respective power source, detecting unit and protecting unit. In the present example, if LED 501 in the C3 position is out of order, the current is promoted and the brightness is compensated by the way as disclosed in the previous paragraphs for the LEDs 505 surrounding the LED 501 which is positioned in C3. Hence, the illumination of the entire LED array is maintained in a required standard.

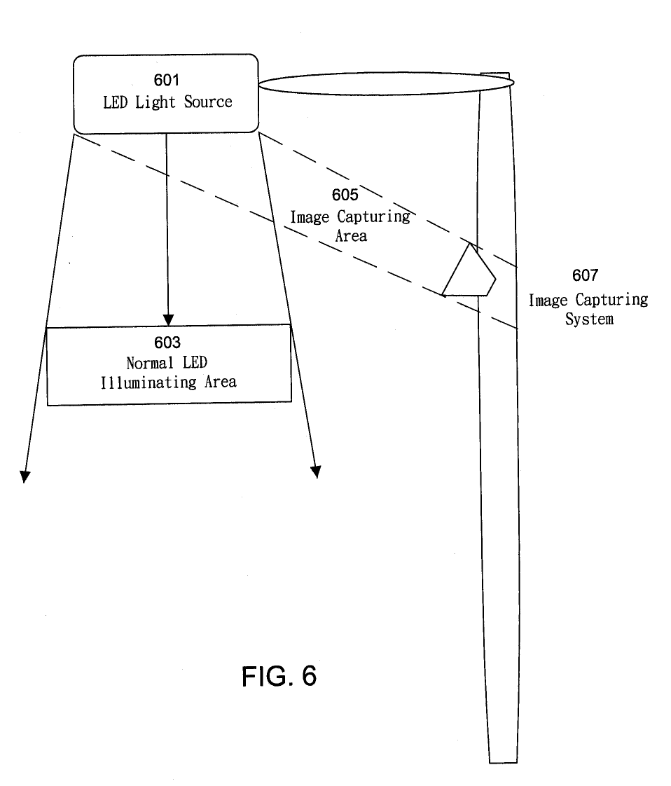

Please refer to FIG. 6, which shows a prescriptive view of a system arrangement of the LED devices with compensation capability of another embodiment of the present invention. The elements same as those in FIG. 1 are marked with same reference numbers. The present system comprises a LED light source 601, a normal LED illuminating area 603, an image capturing area 605 and an image capturing system 607. According to an embodiment of the present invention, the LED light source 601 is constructed by a LED array. Through the image capturing system 607, the brightness of the system is sensed for determining if the brightness is normal or not. If it is out of order, by the way illustrated according to FIG. 1, the processing unit (not shown) can compensate brightness right away and the power controlling unit (not shown) can real-timely compensate. Besides, the position of the image capturing device as shown in FIG. 6 is only for example, those positions capable for capturing image of the LED light source are all possible for mounting the image capturing device.

Though the present invention has been disclosed with reference to several embodiments, however the scope of the present invention is not limited to these details. Modifications or alternatives suggested in aforesaid paragraphs or others are apparent to those in the skill art. Especially, those substantially identical to the present invention to achieve substantially equal result are within the scope of the present invention. Hence, all such modifications or alternatives are within either the scope of claims or equivalents of the present invention.

What is claimed is:

1. A light emitting diode device, comprising:
a plurality of light emitting diodes, when at least one of the plurality of light emitting diodes is out of order, the remaining of the plurality of light emitting diodes can still working properly;
a status detecting unit, coupling to the plurality of light emitting diodes;
a power controlling unit, providing a power outputted to the plurality of light emitting diodes; and
a processing unit, instructing the power controlling unit to adjust the power outputted to the plurality of light emitting diodes according to status signals provided by the status detecting unit.

2. The light emitting diode device of claim 1, wherein the power controlling unit is integrate with the processing unit.

3. The light emitting diode device of claim 1, wherein the plurality of light emitting diodes comprises a plurality of light emitting diodes in serial connection as an unit.

4. The light emitting diode device of claim 1, wherein the status detecting unit comprises voltage detector or current detector.

5. The light emitting diode device of claim 4, wherein the status detecting unit further transmits a PWM output signal from the processing unit to control the brightness of the plurality of light emitting diodes.

6. The light emitting diode device of claim 4, wherein the status detecting unit further comprises an ambient light sensor.

7. The light emitting diode device of claim 1, wherein when at lease one light emitting diode of the plurality of light emitting diodes is out of order, the processing unit instruct the power controlling unit to lower a total input voltage of the plurality of light emitting diodes according to the status signals provided by the status detecting unit, and increase current of respective light emitting diodes to compensate brightness.

8. The light emitting diode device of claim 1, wherein each of the plurality of light emitting diodes is with a corresponding light emitting diode protecting unit.

9. A light emitting diode device, comprising:
a plurality of light emitting diodes, when at least one of the plurality of light emitting diodes is out of order, the remaining of the plurality of light emitting diodes can still working properly;
a status detecting unit, coupling to each of the plurality of light emitting diodes;
a power controlling unit, providing a power outputted to the plurality of light emitting diodes; and
a processing unit, instructing the power controlling unit to adjust the power outputted to the plurality of light emitting diodes according to status signals provided by the status detecting unit;
wherein the plurality of light emitting diodes are divided into a first group and a second group, and the first group and the second group comprise respective power controlling signals and status detecting signals.

10. The light emitting diode device of claim 9, wherein the first group comprises the plurality of light emitting diodes in odd number positions of each row and the second group comprises the plurality of light emitting diodes in even number positions of each row.

11. The light emitting diode device of claim 9, wherein the status detecting unit comprises a voltage detector and a current detector.

12. The light emitting diode device of claim 11, wherein the status detecting unit further transmits a PWM output signal from the processing unit to control the brightness of the plurality of light emitting diodes.

13. The light emitting diode device of claim 11, wherein the status detecting unit further comprises an ambient light sensor.

14. The light emitting diode device of claim 9, wherein when at lease one light emitting diode of the plurality of light emitting diodes is out of order, the processing unit respectively instruct the power controlling unit to lower a total input voltage of the first group and the second group of the plurality of light emitting diodes according to the status signals provided by the status detecting unit, and increase current of respective light emitting diodes to compensate brightness.

15. The light emitting diode device of claim 9, wherein each of the plurality of light emitting diodes is with a corresponding light emitting diode protecting unit.

16. The light emitting diode device of claim 9, wherein the power controlling unit is integrated with the processing unit.

17. The light emitting diode device of claim 9, wherein the plurality of light emitting diodes comprises a plurality of light emitting diodes in a serial connection.

18. A light emitting diode system, comprising:
a light emitting diode array, when at least one light emitting diode of the light emitting diode array is out of order, the remaining light emitting diode in the light emitting diode array can still working properly;
an image capturing system, detecting brightness of the light emitting diode array;
a power controlling unit, providing a power outputted to the plurality of light emitting diode array; and
a processing unit, instructing the power controlling unit to adjust the power outputted to the light emitting diode array according to the signals provided by the image capturing system.

19. The light emitting diode system of claim 18, wherein the power controlling unit is integrated with the processing unit.
